(19) United States
(12) Patent Application Publication
(10) Pub. No.: US 2009/0145741 A1
(43) Pub. Date: Jun. 11, 2009

(54) Method for catalytic treating perfluorocompound gas including particle removing unit

(75) Inventors: Sheng-Jen Yu, Hsinchu (TW); Shou-Nan Li, Hsinchu (TW); Shao-I Yen, Hsinchu (TW); Tzu-Ming Chen, Hsinchu (TW)

Correspondence Address: BACON & THOMAS, PLLC, 625 SLATERS LANE, FOURTH FLOOR, ALEXANDRIA, VA, 22314-1176, US

(73) Assignee: Industrial Technology Research Institute, Hsinchu (TW)

(21) Appl. No.: 12/078,827

(22) Filed: Apr. 7, 2008

(30) Foreign Application Priority Data
Dec. 5, 2007 (TW) 96146244

(51) Int. Cl. B01D 53/68; B01J 19/12

(52) U.S. Cl. 204/157.15; 423/240 R; 423/239.1

(57) ABSTRACT

The present invention relates to a method for treating fluoro-containing and silicon-containing gas. The method comprises treating the gas with thermal-treating, particles-treating, catalyst-treating, and acid-removing sequentially to remove perfluorocompounds. The invention achieves results of reducing the working temperature, increasing the lifetime of the catalyst, reducing the operating cost of the system, and increasing the applications of the catalyst in the aspect of fluoride-containing gas, silicon-containing gas and particles containing gas treatment by sequential treating.

### BACKGROUND OF THE INVENTION

1. Field of the Invention

The present invention relates to a gas treating method, more particularly a method for simultaneously treating gases containing silicon compounds and perfluorocompounds.

2. Description of Related Art

In the process of producing chips or FPDs (Flat Panel Display) in the semiconductor or optoelectronics industries, large amounts of greenhouse gases and particles are emitted. Amongst the present commercial treating equipments, including thermal, combustion and catalytic types of partial treating equipments, if perfluorocompounds (PFC) are processed only by thermal, the required operating energy cost is high. Even if in the processing of some relatively simple-processed perfluorocompounds, such as NF₃, the operating temperature is still higher than 1000° C. For some relatively stable perfluorocompounds, such as CF₄, the removal efficiency is low. As for combustion type equipments, besides their high cost of fuels and low safety, large amount of CO₂ would be emitted, contributing to greenhouse effects. Catalytic type equipments can operate under low operation power. However, if deep submicron particles deposit on the surface of the catalyst, the lifetime and efficiency of the catalyst would be reduced dramatically. Therefore, catalytic type equipments can only be used for some particular processes which have low particle content.

The commercially available partial treating equipments at present which can simultaneously process exhaust gas containing perfluorocompounds, micron and deep submicron particles, Tetraethoxysilane, and silicon hydride, are mainly thermal and combustion type equipments, and their operating temperatures (thermal temperature and combustion temperature) are both higher than 1000° C. The commercially available catalytic type equipments having a operation temperature range 500 to 850° C. can remove PFC effectively, but cannot process exhaust gas containing silicon hydride, Tetraethoxysilane, and deep submicron particles.

Japanese patent JP2005111423A discloses a gas treating process. However, the heating temperature in the heating process is only between 50 to 200° C., which is not sufficient to transform silicon compounds in the gas into silicon oxide particles, and therefore cannot remove the silicon compounds in the gas by filtration but relying on other techniques.

Therefore, the target of this field is to develop a method, which has simple processing steps, low energy consumption, and would be able to process a wide range of gases.

### SUMMARY OF THE INVENTION

In view of the disadvantages in the known art, the object of the present invention is to provide an industrial process, such as exhaust gas treatment in semiconductor and optoelectronics industries, to reduce the operation energy consumption and increase the lifetime of catalyst.

In order to to achieve the above object, the gas treating method of the present invention comprises: (a) thermal-treating both fluoro-containing and silicon-containing gas; (b) particle-treating the gas after thermal-treating to remove particles large than 0.01 μm in the gas; (c) catalyst-treating the gas after particle-treating in step (b) by contacting with catalyst; and (d) removing acids in the gas after catalyst-treating, wherein the above steps are operated at a temperature of 350 to 800° C.

The present invention uses separate solid and gas treating processes, which is not limited to the processing of fluoro-containing gas, but also can be used to process exhaust gases containing perfluorocompounds, micron and deep submicron particles, silanes, and oxysilanessiliconin manufacturing processes of semiconductor or optoelectronics industries, and the temperature of thermal-treating is lower than that of a process which uses single thermal-treating alone to remove fluoro-containing compound.

### BRIEF DESCRIPTION OF THE DRAWINGS

FIG. 1 is the flowchart of gas treating method of the present invention.

FIG. 2 is the trend plot of removing particles by the method of the present invention.

FIG. 3 is the trend plot of removing SiH₄ by the method of the present invention.

FIG. 4 is the trend plot of removing NF₃ by the method of the present invention.

FIG. 5 is the trend plot of removing SF₆ by the method of the present invention.

### DETAILED DESCRIPTION OF THE INVENTION

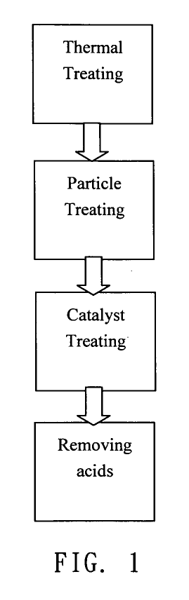

The flowchart of the method of the present invention is shown in FIG. 1, which processes the fluoro-containing and silicon-containing gas by the following steps sequentially: thermal-treating, which is to process the gas at a temperature of 350 to 800° C.; particle-treating the gas to remove particles large than 0.01 μm; catalyst-treating, which is to process the gas at a temperature of 350 to 800° C.; and acid removal.

The condition of providing the thermal-treating temperature of 350 to 800° C. necessary for the present invention can be fulfilled by methods including combustion heating, thermal couple heating, microwave heating etc. The thermal-treating process of the present invention would be able to oxidize the silicon compounds (such as Tetraethoxysilane or silicon hydride) in the processing gas into silicon oxide particles.

The particle-treating step is used to filter the silicon oxide particles, which is originally contained in the gas to be processed or produced during the thermal-treating step. The applicable particle-treating includes bag filtration, wet electrostatic precipitation, water-washing, gravity settling or inertial impact. It can be easily understood that when particles have a wide particle size distribution, particle-treating can process particles with different size separately based upon on their properties. For example, use a bag filter with large pore size to filter particles with large size first, then use a bag with smaller pore size to filter particles with smaller size. Other combinations of the particle removal methods mentioned above, like connecting water-washing with bag filtration, connecting gravity settling with bag filtration, or connecting inertial impact with bag filtration, can be used as needed. The purpose of particle-treating is to pre-process the gas before the following catalys-treating, avoid particles depositing on the surface of catalyst support which will reduce the efficacy of the catalyst.

Besides the thermal-treating and particle-treating to remove silicon compounds, the other object is to connect thermal-treating and particle-treating as the pre-processing for catalytic-treating. Catalytic-treating is to react fluoro-containing gas via catalytic reaction to form hydrofluoric acid. The fluoro-containing gas mentioned in the present invention includes perfluorocompounds (PFC), which can be further divided into fluoro-nitrogen compounds (such as NF₃), fluorocarbon compounds (such as CF₄ or CHF₃) and fluoro-sulfur compounds (such as SF₆). The suitable catalyst for the catalytic-treating can be any catalyst used for processing fluoro-containing gas in the known art, especially the two-stage type catalyst in the other application of the present applicant (first stage is Al₂O₃-based zinc, second stage is Al₂O₃-based copper and cerium), which is used to decompose fluoro-containing compounds. The operation temperature for a catalyst to decompose fluoro-containing compounds depends on the property of the catalyst itself or that of the fluoro-containing compounds in the processing gas. For example, the two-stage type catalyst in the other application, the decomposing temperature for SF₆ is about 580° C., 350° C. for NF₃, and 800° C. for the relatively stable CF₄.

It can be easily understood that each step of the method of the present invention can have their respective operation temperatures, but they also can be operated under the same operation temperature. The difference between prior art and the present invention is: the thermal-treating of the present invention is not used to process fluoro-containing gas, but to transform silicon-containing compound into silicon oxide. Therefore, the operation temperature of the present method is only 400 to 600° C. process gases coming through, while processes using electro-heating or microwave-heating or combustion-heating to decompose fluoro-containing compound require temperatures higher than 1000° C.

Generally speaking, it is not required to limit the gas exhaust in the method of the present invention, because the processing capability of each step can be changed depending on the volume of the gas to be processed as needed. However, in a general embodiment, in order to consider both the processing rate and the completeness of the reaction, gas flow rate of the present invention should be set at 10 to 500 liter per hour, preferably 30 to 250 liter per hour.

In the end, the fluoro-containing compound after catalytic-treating is transformed into hydrofluoric acid, then the hydrofluoric acid is removed by the acid removal step. Generally speaking, the removal step is carried out and completed by water-washing. Besides the hydrofluoric acid formed by fluoro-containing compounds, other acids in the gas, including but not limited to hydrochloric acid and hydrobromic acid, are the compounds to be removed in the acid removal step. Therefore, other techniques with the same acid removal objectives are not excluded. The advantages of the present invention are further depicted with the illustration of examples, which however should not be construed as a limitation of the scope of the claims.

### EXAMPLE 1

### Efficacy of the Gas Treating System of the Present Invention

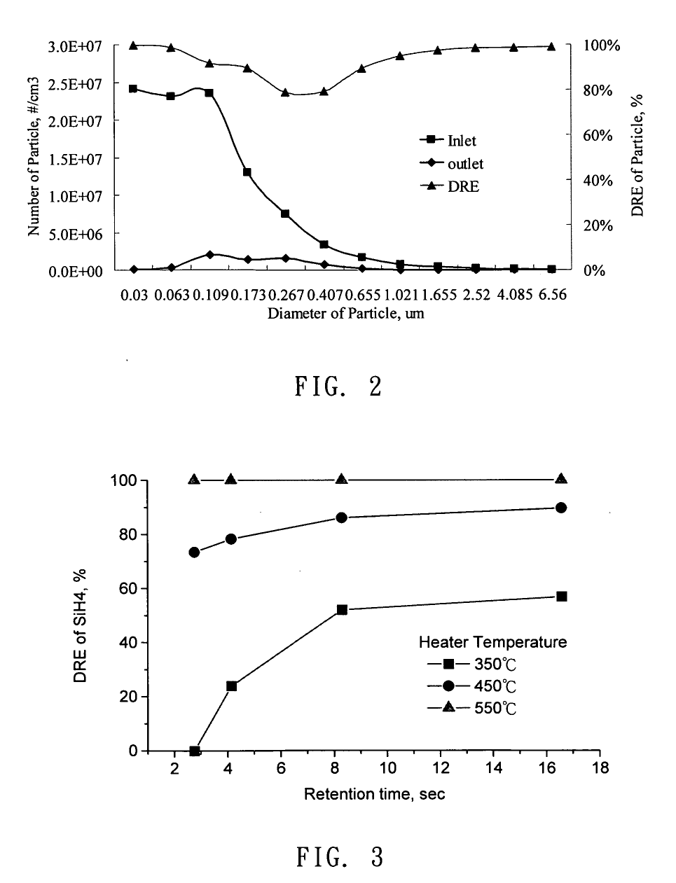

The present embodiment used 10,000 ppm NF₃ (/SF₆) and 10,000 ppm SiH₄ as testing gas to analyze the efficacy of the system, wherein the highest operation temperature is lower than 550° C. (SF₆: 580° C.), the flow rate is 500 lpm (L/min), and the catalyst is the two-stage type catalyst applied in the other patent application. Testing results are shown in FIG. 2 to FIG. 5. FIG. 2 is a trend plot of particle removing when SiH₄ is provided as testing gas before and after particle-treating (bag filtration). It is known from the plot that when the amount of particles formed is below 3×10⁷ particle number/cm³, and size of the particle is 0.03 to 6.56 μm. As the result, the percentage of at least 95% or above particle removing can be achieved.

FIG. 3 is a removing trend plot of for SiH₄ at different temperatures before and after thermal-treating (thermal couple heating). It is known from the plot that at 550° C., SiH₄ is totally transformed into silicon oxide particles.

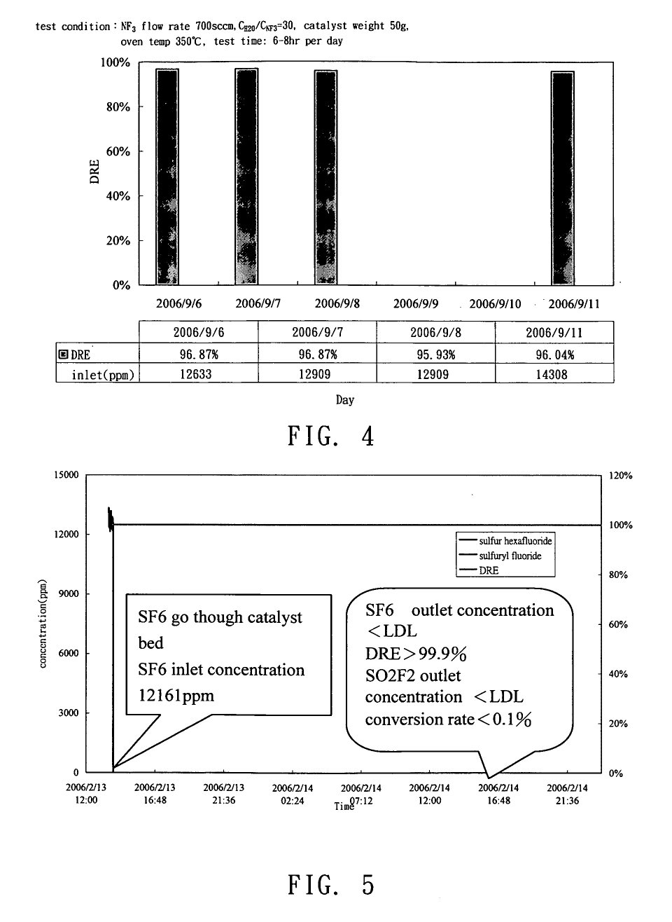

FIG. 4 and FIG. 5 are the removal efficacies when about 12,000 ppm of NF₃ and SF₆ are provided in the system of present invention. For 50 g catalyst used, the testing time for NF₃ is 6 to 8 hours every day, and testing temperature is 350° C.; the testing time for SF₆ is two days in a row, and testing temperature is 580° C. It is known from the plot, the removal efficiencies for NF₃ and SF₆ both achieved percentages higher than 95%.

In summary, the method of the present invention integrates thermal-treating, particle-treating, catalytic-treating and acid removal steps. As demonstrated by experiments, the method of the present invention can effectively remove the gas containing 10,000 ppm SiH₄ and 10,000 ppm fluoro-compound SF₆/NF₃ at a operation temperature of 350 to 800° C., and the removal efficiency is higher than 95% (catalyst operation temperature: SF₆/580° C. and NF₃/350° C.; thermal-treating temperature: 400 to 550° C.). Therefore, the present invention is characterized by the innovation of integrating different kinds of treating methods (thermal-treating, micron and deep submicron particle-treating, catalytic-treating and acid removal), as well as removing SiH₄ and perfluorocompounds in different steps. Furthermore, the method of the present invention can simultaneously process flue gas containing SiH₄, TEOS, deep submicron particles and perfluorocompounds, and the overall operation temperature is lower than that of commercially available products targeting the same function, and the operation range of particle size is wider than that of the embodiments of other inventions.

### OTHER EXAMPLES

All technical features disclosed in this specification can be combined with other processes, and every single technical feature can be selectively substituted by features the same with, equal to, or similar to the aimed features. Therefore, each technical feature disclosed in this specification is merely an example equal to or similar to the aimed features.

The preferred embodiments of the present invention have been disclosed above, but these embodiments are not used to limit the present invention. Those skilled in the art can make various changes and modifications without departing the spirit of the present invention.

What is claimed is:

1. A method for catalytically treating a gas containing perfluorocompounds, including a particle removing unit, comprising the steps of:
(a) thermal-treating both fluoro-containing and silicon-containing gas;
(b) particle-treating the gas after said thermal-treating to remove particles large than 0.01 μm in the gas;
(c) catalyst-treating the gas after the particle-treating in step (b) by contacting with catalyst; and
(d) removing acids after the catalytically treated gas;
wherein above steps are carried out in 350 to 800° C.

2. The method according to claim 1, wherein said thermal-treating includes combustion heating, thermal couple heating or microwave heating.

3. The method according to claim 1, wherein said thermal-treating is used to oxidize silicon compounds into particles.

4. The method according to claim 3, wherein said silicon compound includes Tetraethoxysilane or silicon hydride.

5. The method according to claim 1, wherein said particle-treating includes bag filtration, wet electrostatic precipitation, water-washing, gravity settling or inertial impact and combinations thereof.

6. The method according to claim 1, wherein said fluoro-containing gas includes fluoro-hydrocarbon compounds, fluoro-nitrogen compounds or fluoro-sulfur compounds or mixtures thereof.

7. The method according to claim 1, wherein said thermal-treating is to process the gas at a temperature of 400 to 550° C.

8. The method according to claim 1, wherein said acid in step (d) is removed by water-washing.

9. The method according to claim 1, wherein said acid in step (d) includes hydrofluoric acid, hydrochloric acid, or hydrobromic acid.
